(19) United States
(12) Patent Application Publication
(10) Pub. No.: US 2026/0192889 A1
(43) Pub. Date: Jul. 9, 2026

(54) SHARED FLOATING WIND TURBINE FOUNDATION ARRAY WITH ANGLE-ADJUSTABLE ELASTIC MOORINGS

(71) Applicant: JIANGSU UNIVERSITY OF SCIENCE AND TECHNOLOGY, Jiangsu (CN)

(72) Inventors: Sheng Xu, Jiangsu (CN); Wei Zhang, Jiangsu (CN); Kun Ju, Jiangsu (CN); Xin Chen, Jiangsu (CN)

(73) Assignee: JIANGSU UNIVERSITY OF SCIENCE AND TECHNOLOGY, Jiangsu (CN)

(21) Appl. No.: 19/412,805

(22) Filed: Dec. 8, 2025

(30) Foreign Application Priority Data
Jan. 6, 2025 (CN) 202510012608.4

(51) Int. Cl. B63B 21/16; F03D 13/25; B63B 35/44

(52) U.S. Cl. CPC B63B 21/16; F03D 13/256; B63B 2035/446; F05B 2240/93; F05B 2240/96

(57) ABSTRACT

A shared floating wind turbine foundation array with angle-adjustable elastic moorings is formed by connecting floating wind turbine foundations. Each floating wind turbine foundation includes a wind turbine tower, upper pontoons, a truss framework, lower mooring drums, a lower wind turbine hollow pile, a fixed static mooring line and a shared anchor; the lower wind turbine hollow pile includes a lifting plate, a hydraulic rod and a hydraulic device, the elastic chamber is internally provided with a pressure plate and an elastic device; and a first electric winch and a second electric winch are arranged in the winch chamber, and the first electric winch and the second electric winch drive the rotation of the adjacent lower wind turbine hollow piles by adjusting a length difference between the first power mooring line and the second power mooring line, thereby changing an angle of the adjacent wind turbine towers.

### CROSS-REFERENCE TO RELATED APPLICATION

This application claims the priority benefit of China application serial no. 202510012608.4, filed on January 06, 2025. The entirety of the above-mentioned patent application is hereby incorporated by reference herein and made a part of this specification.

### BACKGROUND

### Technical Field

The present disclosure relates to the field of marine engineering technology, and in particular to a shared floating wind turbine foundation array with angle-adjustable elastic moorings.

### Description of Related Art

In recent years, due to the limited available coastline, offshore wind turbines have gradually been developed toward deeper waters. Floating offshore wind turbines are adaptable to deep-water environments, and offer advantages such as stable power generation and high wind energy utilization, thereby having broad application prospects. However, compared with fixed-bottom wind turbines, floating wind turbines are subjected to far more complex loads from wind, waves, and currents, which pose significant challenges to the design of turbine foundations and mooring systems.

During operation, floating offshore wind turbine systems are affected by aerodynamic loads, hydrodynamic loads, and seabed soil loads. In addition, deep-sea environments are more complex and severe, and these factors can have a serious negative impact on the floating wind turbines. Facing these challenges in the operation of floating offshore wind turbine platforms, the industry is urgently seeking research and innovations in marine engineering and technological equipment to improve operational efficiency, ensure operational safety, and reduce operational costs.

At present, some new structural types of floating offshore wind turbine foundations employing single-point mooring systems can reduce the number of mooring cables and lower mooring costs. However, higher reliability requirements are imposed on the single-point mooring systems in terms of automatic yaw control, especially due to transient tension variations in the mooring lines caused by significant platform motions during dynamic yawing, as well as the ultimate strength of the mooring lines under extreme working conditions.

In addition, the existing floating offshore wind turbine foundations using the multi-point mooring rely on the restoring force provided by multiple mooring lines to offset external loads acting on the turbine. However, these systems involve high design costs, complex installation procedures, and difficult maintenance, which significantly hinder the economic competitiveness of offshore wind power in the future energy market. Moreover, maintaining the stability of offshore floating wind turbines simply rely on the multi-point mooring is often ineffective in deep and harsh marine environments, and such systems cannot fully meet the performance requirements of floating wind turbines in deep-sea regions.

Therefore, from both technical and economic perspectives, the development of floating offshore wind power technology will inevitably revolve around improving platform stability and reducing platform costs. Specifically, improving platform stability and reducing platform motions aim to improve the overall performance and reliability of the system, while reducing manufacturing, installation, and maintenance costs aim to make the floating wind turbine platforms more economically competitive than other forms of energy.

In view of the problems of poor platform stability and high economic costs in the prior art, there is an urgent need to develop structural solutions that can improve platform safety and stability while forming a floating wind turbine foundation array that shares anchoring foundations and enables mutual yaw control, thereby increasing the power generation efficiency of floating offshore wind turbines and reducing mooring costs.

### SUMMARY

In order to overcome the problems of poor platform safety and stability, low efficiency, and high economic cost existing in the prior art, the present disclosure provides a shared floating wind turbine foundation array with angle-adjustable elastic moorings. By lowering a wind turbine tower, adjusting an angle of the floating wind turbine foundation and its windward orientation, and introducing elastic buffering, the present disclosure effectively reduces the impact of harsh marine environments. Specifically, by adopting a wind turbine tower with a hollow lower pile and an elastic chamber within the lower mooring drum, the present disclosure improves the load-bearing performance and enhances platform safety and stability through tower lowering and elastic buffering. In addition, by adopting electric winches arranged in the lower mooring drum and a shared anchoring arranged in a regular hexagonal pattern, the present disclosure provides a regular hexagonal floating wind turbine foundation arrays that share anchoring foundations and mutually control one another, improving the power generation efficiency, economic performance, safety, stability, and service life of the floating wind turbines, while reducing mooring costs and enhancing the load-bearing capacity and recoverability of the mooring systems.

Technical solution: the present disclosure provides a shared floating wind turbine foundation array with angle-adjustable elastic moorings, which is formed by connecting floating wind turbine foundations. Each floating wind turbine foundation includes a wind turbine tower, upper pontoons, a truss framework, lower mooring drums, a lower wind turbine hollow pile, a fixed static mooring line and a shared anchor;

A circumferential support ring is sleeved around the wind turbine tower, the upper pontoons are arranged around the wind turbine tower in an equilateral triangular pattern, a bottom of each upper pontoon is connected to the shared anchor through the fixed static mooring line, and a middle portion of each upper pontoon is connected to adjacent upper pontoons, the circumferential support ring and the corresponding lower mooring drum via the truss framework; and

the lower wind turbine hollow pile includes a lifting plate, a hydraulic rod and a hydraulic device, the wind turbine tower is fixed above the lifting plate, and the hydraulic device drives the lifting plate and the wind turbine tower to move via the hydraulic rod.

Each lower mooring drum includes a hollow chamber, an elastic chamber, and a winch chamber, and a first power hole is formed between the elastic chamber and the winch chamber; the elastic chamber is internally provided with a pressure plate and an elastic device; the pressure plate is an arc-shaped rigid plate having a second power hole, and the elastic device is disposed between an arc-shaped convex surface of the pressure plate and an inner wall of the lower mooring drum, and a third power hole is formed in a bottom of the lower mooring drum; a first electric winch and a second electric winch are arranged in the winch chamber, the first electric winch is wound with a first power mooring line, and the second electric winch is wound with a second power mooring line; and one end of each of the first power mooring line and the second power mooring line passes through the first power hole and enters the elastic chamber, then passes through the second power hole in the pressure plate, exits from an outer side of the pressure plate and a third power hole of the lower mooring drum, and is finally connected to adjacent lower wind turbine hollow piles; and

The first electric winch and the second electric winch drive the rotation of the adjacent lower wind turbine hollow piles by adjusting a length difference between the first power mooring line and the second power mooring line, thereby changing an angle of the wind turbine towers supported by the adjacent lower wind turbine hollow piles.

A mooring shackle for connecting the first power mooring line and the second power mooring line is arranged on a bottom of the lower wind turbine hollow pile.

The lower mooring drums are arranged around the wind turbine tower in an equilateral triangular pattern.

An upper portion of each upper pontoon is a hollow member, and a lower portion of each upper pontoon is a reinforced concrete structural member, thereby providing buoyancy for the entire wind turbine foundation.

The pressure plate is an arc-shaped rigid plate having two second power holes.

The elastic device is an array of springs arranged between an arc-shaped convex surface of the pressure plate and an inner wall of the lower mooring drum.

The floating wind turbine foundations are arranged in a regular hexagonal pattern to form the floating wind turbine foundation array, thereby improving the stability and economic performance of the floating wind turbines.

The shared anchor is located at a center of the floating wind turbine foundation array.

A horizontal angle between each lower mooring drum and the corresponding upper pontoon is 60°. The lower mooring drums are arranged around the wind turbine tower in an equilateral triangular pattern.

The hollow chamber is a hollow and sealed body located above the elastic chamber and the winch chamber, and is configured to provide buoyancy for the lower mooring drums.

Operating principle: For the shared floating wind turbine foundation array with angle-adjustable elastic moorings provided in the present disclosure, the bottom end of the wind turbine tower is connected to the lower wind turbine hollow pile, and the wind turbine tower is controlled to descend into the interior of the lower wind turbine hollow pile. The upper pontoons are arranged around the wind turbine tower, with their bottoms connected to the shared anchor through the fixed static mooring line. Each upper pontoon is connected to adjacent upper pontoons, the wind turbine tower, and the corresponding lower mooring drum via the truss framework. The lower mooring drum is rigidly connected to the lower wind turbine hollow pile, and includes an elastic chamber and a winch chamber to provide elastic restoring force for the wind turbine foundation. Meanwhile, the lower mooring drum is connected to adjacent lower wind turbine hollow piles via the power mooring lines, forming the wind turbine foundation array to control the angle of each wind turbine foundation.

Beneficial effects: Compared with the prior art, the shared floating wind turbine foundation array with angle-adjustable elastic moorings provided in the present disclosure has the following advantages:

(1) The present disclosure employs the lower wind turbine hollow pile that utilizes a hydraulic device to drive the wind turbine tower to move up and down. In case of extreme weather such as typhoons, the wind turbine tower moves downward to descend an interior of the lower wind turbine hollow pile, thereby lowering the center of gravity of the wind turbine foundation, this ensures the structural safety of the wind turbine tower while enhancing the stability of the wind turbine foundation, allowing the wind turbine to operate smoothly in complex and harsh deep-sea environments.

(2) By adopting an elastic chamber design in the lower mooring drum, the pressure plate and the elastic device in the elastic chamber effectively help the mooring line absorb impact force, thereby enhancing the elastic resilience of the mooring line and improving the overall safety and stability of the mooring systems.

(3) A winch chamber is arranged in the lower mooring drum, and the lengths of the power mooring lines are adjusted through the electric winches arranged in the winch chamber. The two power mooring lines finally connected to the adjacent lower wind turbine hollow piles have different lengths, thereby driving the lower wind turbine hollow piles to rotate and to further adjust the angle of the upper wind turbine tower. Under normal operating conditions, this configuration enables the turbine blades of the wind turbine to maintain optimal alignment with the windward orientation, maximizing power generation efficiency and extending the service life of the floating wind turbines.

(4) The floating wind turbine foundations in the present disclosure are arranged in a regular hexagonal pattern, which optimizes a coverage area, minimizes overlap and blank regions, and makes the wind turbine foundation array have higher spatial utilization efficiency. This configuration facilitates flexible scaling of the wind turbine foundation array, simplifying design and reducing deployment costs.

(5) The upper pontoon is connected via the fixed static mooring line to the shared anchor located at the center of the hexagon. This design improves the installation and maintenance efficiency of the mooring systems and optimizes load distribution of the mooring systems, ensuring that each anchor and mooring device bear a reasonable load, thereby improving the stability and economic performance of the floating wind turbines, and enhancing economic competitiveness of offshore wind power in the future energy market.

### BRIEF DESCRIPTION OF THE DRAWINGS

FIG. 1 is a schematic structural diagram of a floating wind turbine foundation according to the present disclosure.

FIG. 2 is a top view of a structure of a floating wind turbine foundation according to the present disclosure.

FIG. 3 is a sectional view of a lower wind turbine hollow pile according to the present disclosure.

FIG. 4 is a schematic diagram of lifting and lower of a wind turbine tower according to the present disclosure.

FIG. 5 is a front sectional view of a lower mooring drum according to the present disclosure.

FIG. 6 is a side sectional view of a lower mooring drum according to the present disclosure.

FIG. 7 is a top sectional view of a lower mooring drum according to the present disclosure.

FIG. 8 is a schematic diagram of an internal structure according to the present disclosure.

FIG. 9 is a schematic diagram illustrating connection between wind turbine foundations according to the present disclosure.

FIG. 10 is a schematic diagram of a shared floating wind turbine foundation array with flexible and controllable moorings according to the present disclosure.

FIG. 11 is a schematic diagram of distribution of a shared floating wind turbine foundation array with flexible and controllable moorings according to the present disclosure.

### DETAILED DESCRIPTIONS OF THE EMBODIMENTS

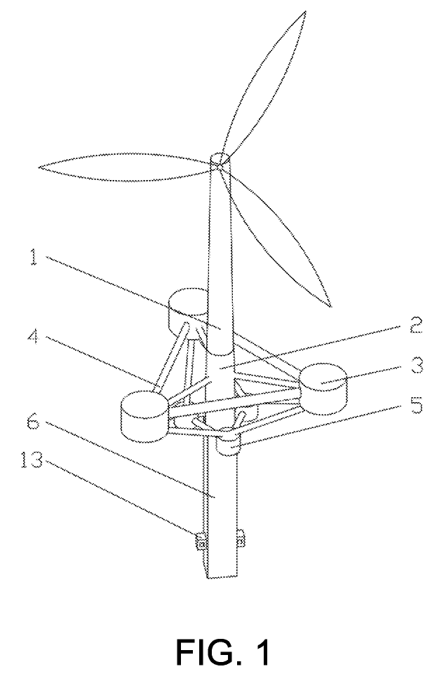

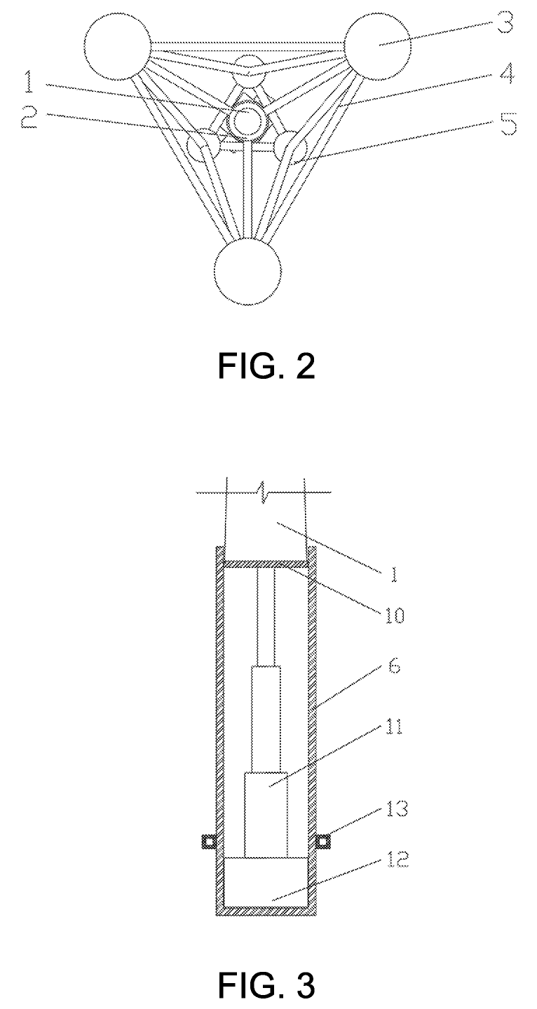

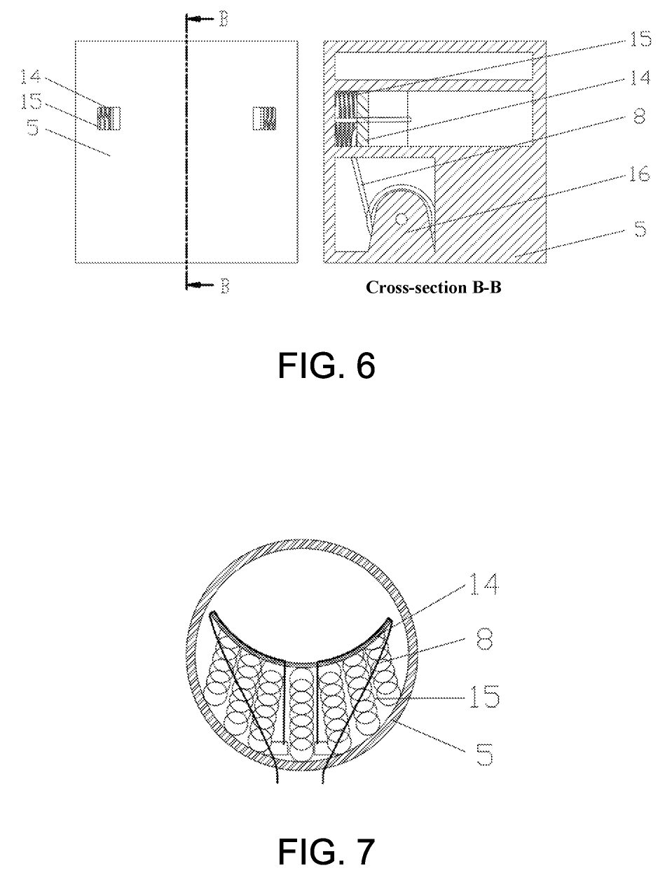

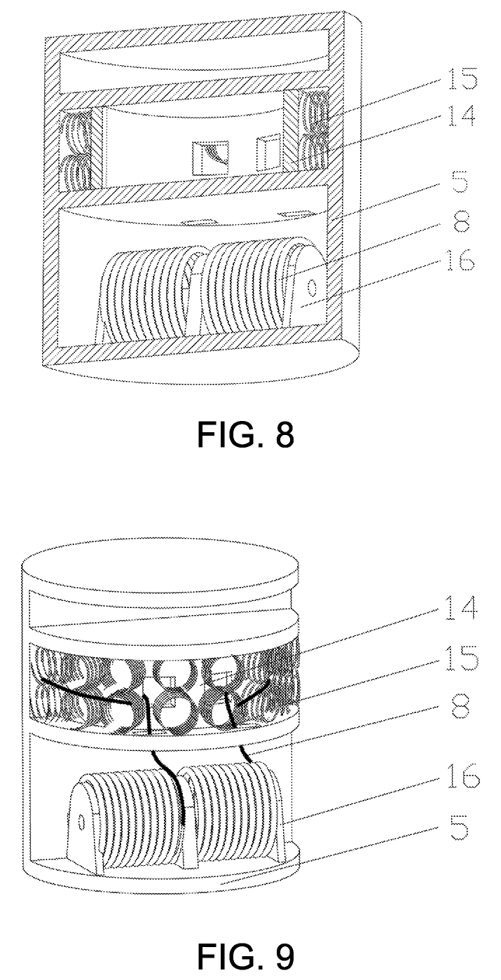

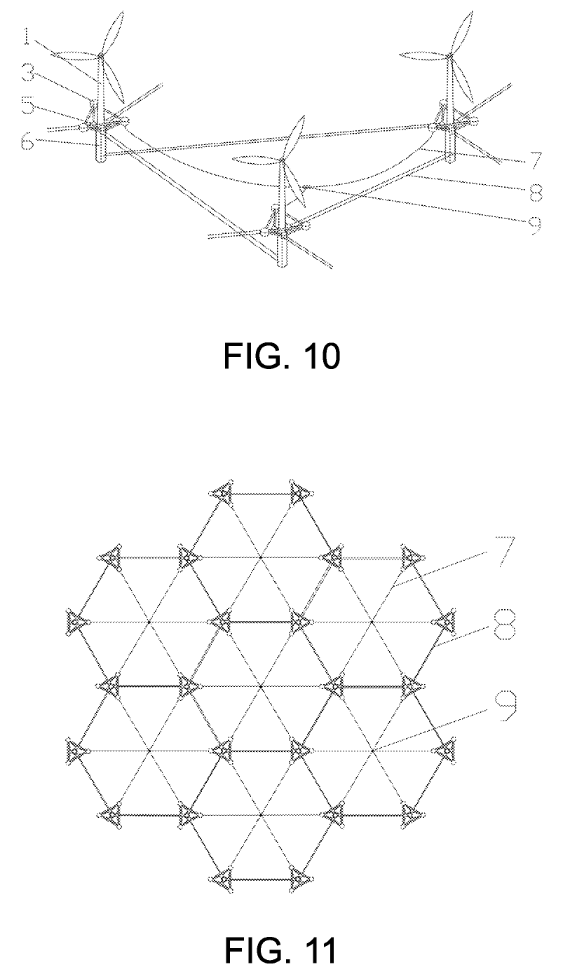

As shown in FIGS. 1-11, the present disclosure provides a shared floating wind turbine foundation array with angle-adjustable elastic moorings, and the shared floating wind turbine foundation array is formed by interconnected floating wind turbine foundations. Each floating wind turbine foundation includes a wind turbine tower 1, a circumferential support ring 2, upper pontoons 3, a truss framework 4, lower mooring drums 5, a lower wind turbine hollow pile 6, a fixed static mooring line 7, a power mooring line 8, and a shared anchor 9. The floating wind turbine foundations are arranged in a regular hexagonal configuration, with the shared anchor 9 located at a center of the hexagon.

A bottom end of the wind turbine tower 1 is connected to the lower wind turbine hollow pile 6, and a cylindrical body of the wind turbine tower 1 is reinforced and supported by the circumferential support ring 2; and an interior of the circumferential support ring 2 is in contact with the wind turbine tower 1, and an exterior of the circumferential support ring 2 is fixedly connected to the upper pontoon 3 through the truss framework 4.

An upper portion of each upper pontoon 3 is a hollow member, a lower portion of each upper pontoon is a reinforced concrete structural member, and they are arranged around the wind turbine tower 1 in an equilateral triangular pattern, providing buoyancy for the entire wind turbine foundation. A bottom of each upper pontoon 3 is connected to the shared anchor 9 through the fixed static mooring line 7, and a middle portion of each upper pontoon is connected to adjacent upper pontoons 3, the circumferential support ring 2, and the lower mooring drums 5 via the truss framework 4.

The lower mooring drums 5 are arranged in the same configuration as the upper pontoons 3, and each lower mooring drum 5 and the corresponding upper pontoon 3 form an angle of 60°. In this embodiment, each lower mooring drum 5 forms an angle of 60° with the corresponding upper pontoon 3, and the lower mooring drums are arranged around the wind turbine tower 1 in an equilateral triangular pattern and rigidly connected to the lower wind turbine hollow pile 6, and each lower mooring drum is connected to adjacent lower mooring drums 5 and the upper pontoons 3 through the truss framework 4, thus, the interconnected floating wind turbine foundation is formed by the truss framework 4, the wind turbine tower 1, the upper pontoons 3, the lower mooring drums 5, and the lower wind turbine hollow pile 6. In addition, each lower mooring drum is further connected to the mooring shackle 13 at a bottom of adjacent lower wind turbine hollow pile 6 via the power mooring line 8. Each lower mooring drum 5 and the corresponding upper pontoon 3 form an angle of 60°. Length and angle of the truss framework for connecting the same lower mooring drum are equal, ensuring uniform force distribution and avoiding eccentric moments.

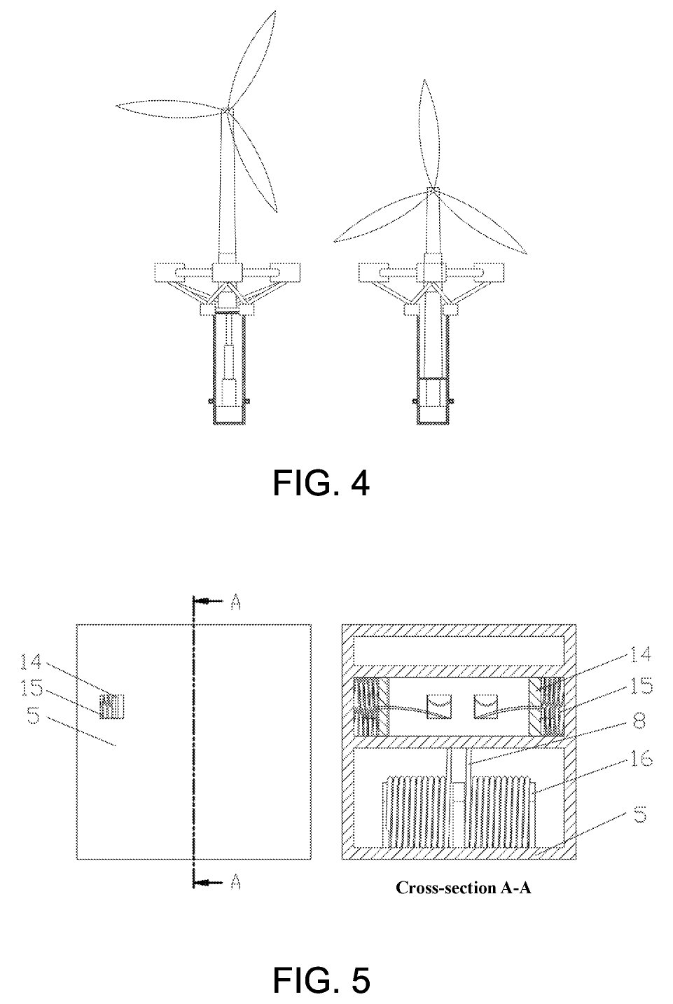

As shown in FIGS. 3 and 4, the lower wind turbine hollow pile 6 includes a lifting plate 10, a hydraulic rod 11, a hydraulic device 12, and a mooring shackle 13. The hydraulic device 12 is located at a bottom interior of the lower wind turbine hollow pile 6 and is connected to the lifting plate 10 via the hydraulic rod 11. A bottom of the lifting plate 10 is rigidly connected to the hydraulic rod 11, and a top of the lifting plate is rigidly connected to the wind turbine tower 1. When the lower wind turbine hollow pile 6 rotates, the wind turbine tower 1 within the lower wind turbine hollow pile also rotates synchronously; that is, an angle of the wind turbine tower 1 is the same as an angle of the lower wind turbine hollow pile 6. By controlling the hydraulic device 12 to extend or retract the hydraulic rod 11, the lifting plate 10 is driven to move up and down, enabling the wind turbine tower 1 to descend an interior of the lower wind turbine hollow pile 6. This configuration achieves the purposes of avoiding extreme weather at sea, protecting the wind turbine tower 1 and the mooring systems, and extending the service life of the floating wind turbine.

As shown in FIGS. 5-8, each lower mooring drum 5 includes a hollow chamber, an elastic chamber, and a winch chamber. A first power hole is formed in an outer surface and between the elastic chamber and the winch chamber of the lower mooring drum 5, allowing the power mooring line 8 to pass through. The hollow chamber is a hollow and sealed body that provides buoyancy for the lower mooring drum 5. The elastic chamber contains a pressure plate 14 and an elastic device 15. The pressure plate 14 is an arc-shaped rigid plate having two second power holes. The elastic device 15 consists of a series of spring arrays arranged between an arc-shaped convex surface of the pressure plate 14 and an inner wall of the lower mooring drum 5, with both ends rigidly connected. Being subjected to external force, the power mooring line 8 transfers the load to the elastic device 15 by means of the pressure plate 14, thereby better absorbing impact energy and mitigating vibration to improve mooring safety.

Two electric winches 16, designated as a first electric winch and a second electric winch, each having a power mooring line 8 is arranged in the winch chamber. The first electric winch is wound with a first power mooring line, and the second electric winch is wound with a second power mooring line.

As shown in FIG. 9, one end of each of the first power mooring line and the second power mooring line is wound on the corresponding electric winch 16, and the other end thereof passes through the first power hole between the elastic chamber and the winch chamber and enters the elastic chamber, and then passes through the second power hole in the pressure plate 14 to reach a concave side of the pressure plate 14, subsequently loops back to an outer side of the pressure plate 14 via both lateral sides of the pressure plate, finally exits from a third power hole at a bottom of the lower mooring drum 5, and is connected to the mooring shackle 13 of the adjacent lower wind turbine hollow piles 6.

Lengths of the two power mooring lines may be adjusted by the power of the electric winch 16. Since the first power mooring line and the second power mooring line finally connected to adjacent lower wind turbine hollow piles 6 have different lengths, the connected adjacent lower wind turbine hollow piles 6 are driven to rotate, and an angle of the wind turbine tower 1 above the connected adjacent lower wind turbine hollow piles 6 is accordingly changed, which achieves the purposes of controlling the angle of the adjacent floating wind turbines and changing an orientation of the wind turbine tower in real time according to the environment, thereby improving the power generation efficiency of the floating wind turbines.

As shown in FIGS. 9-11, in this embodiment, the floating wind turbine foundations are arranged in a regular hexagonal pattern. Each upper pontoon 3 is connected via the fixed static mooring line 7 to the shared anchor 9 located at the center of the hexagon, while each lower mooring drum 5 is connected via the power mooring line 8 to the lower wind turbine hollow pile 6 of an adjacent floating wind turbine foundation, in this way, a regular hexagonal array of floating wind turbine foundations that shares anchoring foundations and mutually control one another is formed, thereby improving the stability and economic performance of the floating wind turbines.

What is claimed is:

1. A shared floating wind turbine foundation array with angle-adjustable elastic moorings, wherein the shared floating wind turbine foundation is formed by connecting floating wind turbine foundations, and each of the floating wind turbine foundations comprises a wind turbine tower, upper pontoons, a truss framework, lower mooring drums, a lower wind turbine hollow pile, a fixed static mooring line and a shared anchor;
a circumferential support ring is sleeved around the wind turbine tower, the upper pontoons are arranged around the wind turbine tower in an equilateral triangular pattern, a bottom of each of the upper pontoons is connected to the shared anchor through the fixed static mooring line, and a middle portion of each of the upper pontoons is connected to adjacent upper pontoons, the circumferential support ring and the corresponding lower mooring drum via the truss framework;
the lower wind turbine hollow pile comprises a lifting plate, a hydraulic rod and a hydraulic device; and the wind turbine tower is fixed above the lifting plate, and the hydraulic device drives the lifting plate and the wind turbine tower to move via the hydraulic rod;
each of the lower mooring drums comprises a hollow chamber, an elastic chamber, and a winch chamber, a first power hole is formed between the elastic chamber and the winch chamber; the elastic chamber is internally provided with a pressure plate and an elastic device; and the pressure plate is an arc-shaped rigid plate having a second power hole, and the elastic device is disposed between an arc-shaped convex surface of the pressure plate and an inner wall of the lower mooring drum, and a third power hole is formed in a bottom of the lower mooring drum;
a first electric winch and a second electric winch are arranged in the winch chamber, the first electric winch is wound with a first power mooring line, and the second electric winch is wound with a second power mooring line; and one end of each of the first power mooring line and the second power mooring line passes through the first power hole and enters the elastic chamber, then passes through the second power hole in the pressure plate, exits from an outer side of the pressure plate and a third power hole of the lower mooring drum, and is finally connected to adjacent lower wind turbine hollow piles; and
the first electric winch and the second electric winch drive the rotation of the adjacent lower wind turbine hollow piles by adjusting a length difference between the first power mooring line and the second power mooring line, thereby changing an angle of the wind turbine tower supported by the adjacent lower wind turbine hollow piles.

2. The shared floating wind turbine foundation array with angle-adjustable elastic moorings according to claim 1, wherein a mooring shackle for connecting the first power mooring line and the second power mooring line is arranged on a bottom of the lower wind turbine hollow pile.

3. The shared floating wind turbine foundation array with angle-adjustable elastic moorings according to claim 1, wherein the lower mooring drums are arranged around the wind turbine tower in an equilateral triangular pattern.

4. The shared floating wind turbine foundation array with angle-adjustable elastic moorings according to claim 1, wherein an upper portion of each of the upper pontoons is a hollow member, and a lower portion of each of the upper pontoons is a reinforced concrete structural member.

5. The shared floating wind turbine foundation array with angle-adjustable elastic moorings according to claim 1, wherein the pressure plate is an arc-shaped rigid plate having two second power holes.

6. The shared floating wind turbine foundation array with angle-adjustable elastic moorings according to claim 1, wherein the elastic device is an array of springs arranged between an arc-shaped convex surface of the pressure plate and an inner wall of the lower mooring drum.

7. The shared floating wind turbine foundation array with angle-adjustable elastic moorings according to claim 1, wherein the floating wind turbine foundations are arranged in a regular hexagonal pattern to form the floating wind turbine foundation array.

8. The shared floating wind turbine foundation array with angle-adjustable elastic moorings according to claim 7, wherein the shared anchor is located at a center of the floating wind turbine foundation array.

9. The shared floating wind turbine foundation array with angle-adjustable elastic moorings according to claim 1, wherein a horizontal angle between each of the lower mooring drums and the corresponding upper pontoon is 60°.

10. The shared floating wind turbine foundation array with angle-adjustable elastic moorings according to claim 1, wherein the hollow chamber is a hollow and sealed body located above the elastic chamber and the winch chamber.
